(19) United States
(12) Patent Application Publication
(10) Pub. No.: US 2021/0362833 A1
(43) Pub. Date: Nov. 25, 2021

(54) STRUCTURAL COMPOSITE AIRFOILS WITH A MULTI-SPAR PIECE, AND RELATED METHODS

(71) Applicant: The Boeing Company, Chicago, IL (US)

(72) Inventors: Bryan Gruner, Bellevue, WA (US); Donald Drew Reinhart, Snohomish, WA (US)

(21) Appl. No.: 16/880,130

(22) Filed: May 21, 2020

(51) Int. Cl. B64C 9/00; B64C 3/18; B64C 3/26; B64F 5/10

(52) U.S. Cl. CPC B64C 9/00; B64F 5/10; B64C 3/26; B64C 3/185

(57) ABSTRACT

Structural composite airfoils include a primary structural element, and a secondary structural element defining a trailing edge of the structural composite airfoil. The primary structural element extends from a leading edge region to a trailing edge region, with the leading edge region of the primary structural element forming a leading edge of the structural composite airfoil. The primary structural element includes an upper skin panel, a lower skin panel, and a spar. The spar includes a plurality of upper flanges coupled to the upper skin panel and a plurality of lower flanges coupled to the lower skin panel. The spar extends spanwise across the structural composite airfoil. The spar also extends along a chord length of the structural composite airfoil. The spar may be a unitary, monolithic body, with an elongated span extending between each adjacent upper flange and lower flange.

### FIELD

The present disclosure relates generally to structural composite airfoils and related methods.

### BACKGROUND

Aircraft, including fixed-wing aircraft and rotary-wing aircraft, employ a variety of aerodynamic control surfaces, such as ailerons, air brakes, elevators, flaps, rudders, slats, spoilers and the like. By manipulating one or more of the aerodynamic control surfaces, a pilot may control the lift generated by the aircraft, such as during takeoff, climbing, descending and landing, as well as the aircraft's orientation about its pitch, roll, and yaw axes. For example, the trailing edge of a wing of a fixed-wing aircraft typically includes one or more flaps, with the flaps being moveable between retracted and extended positions. At cruise, the flaps are typically maintained in a retracted position. When extended, the flaps increase the camber of the wing. Therefore, during takeoff, climbing, descending, or landing, the flaps may be extended, either partially or fully, to increase the maximum lift coefficient and effectively reduce the stalling speed of the aircraft. Said aerodynamic control surfaces are typically airfoils formed of composite materials, and thus are referred to herein as structural composite airfoils.

Structural composite airfoils, such as flaps, have an aerodynamic cross-sectional profile that is typically formed by connecting an upper skin to a lower skin proximate both the leading edge and the trailing edge of the structural composite airfoil. In conventional construction of inboard and outboard flaps, for example, a primary structural element of the flap is defined by the upper and lower skins being coupled to three spars that extend the width of the flap. The leading edge of the structural composite airfoil (which typically includes a bullnose shape), and the trailing edge (which is tapered to a thin cross-section) are typically outside of the primary structural element, forming respective secondary structural elements of the flap. Various fasteners and components (e.g., splice straps and/or nut plates) are used to secure the upper and lower skins to the spars and other structures that form the flap. Large numbers of fasteners can increase costs, manufacturing cycle time, and weight of the resulting assemblies. Accordingly, those skilled in the art continue research and development efforts directed to improving structural composite airfoils and the manufacturing thereof.

### SUMMARY

Disclosed structural composite airfoils and related methods of forming said structural composite airfoils may reduce fastener counts, improve airfoil aerodynamic surfaces, and/or simplify manufacturing processes for structural composite airfoils.

An example of a structural composite airfoil according to the present disclosure includes a primary structural element, and a secondary structural element defining a trailing edge of the structural composite airfoil. The primary structural element extends from a leading edge region to a trailing edge region, with the leading edge region of the primary structural element forming a leading edge of the structural composite airfoil. The primary structural element includes an upper skin panel extending from an upper leading edge end to an upper trailing edge end, a lower skin panel extending from a lower leading edge end to a lower trailing edge end, and a spar. An internal volume is defined between the upper skin panel and the lower skin panel. The spar includes a plurality of upper flanges coupled to the upper skin panel, and a plurality of lower flanges coupled to the lower skin panel. The spar extends spanwise across the structural composite airfoil. The spar also extends along a chord length of the structural composite airfoil, from a spar leading edge end to a spar trailing edge end. The spar may be a unitary, monolithic body, with an elongated span extending between each adjacent upper flange and lower flange.

Methods of assembling said structural composite airfoils are also disclosed. Disclosed methods generally include coupling the upper skin panel to the plurality of upper flanges of the spar and coupling the lower skin panel to the plurality of lower flanges of the spar such that an internal volume is defined between the upper skin panel and the lower skin panel. Methods also include forming the leading edge of the structural composite airfoil with the upper skin panel, and coupling the upper leading edge end of the upper skin panel to a forward-most lower flange of the plurality of lower flanges of the spar.

### BRIEF DESCRIPTION OF THE DRAWINGS

FIG. 1 is a schematic representation of an apparatus that may include one or more structural composite airfoils according to the present disclosure.

FIG. 2 is a schematic, side elevation representation of examples of structural composite airfoils according to the present disclosure.

FIG. 3 is a schematic, side elevation representation of examples of structural composite airfoils according to the present disclosure.

FIG. 4 is a flowchart diagram representing disclosed methods of forming disclosed structural composite airfoils.

### DESCRIPTION

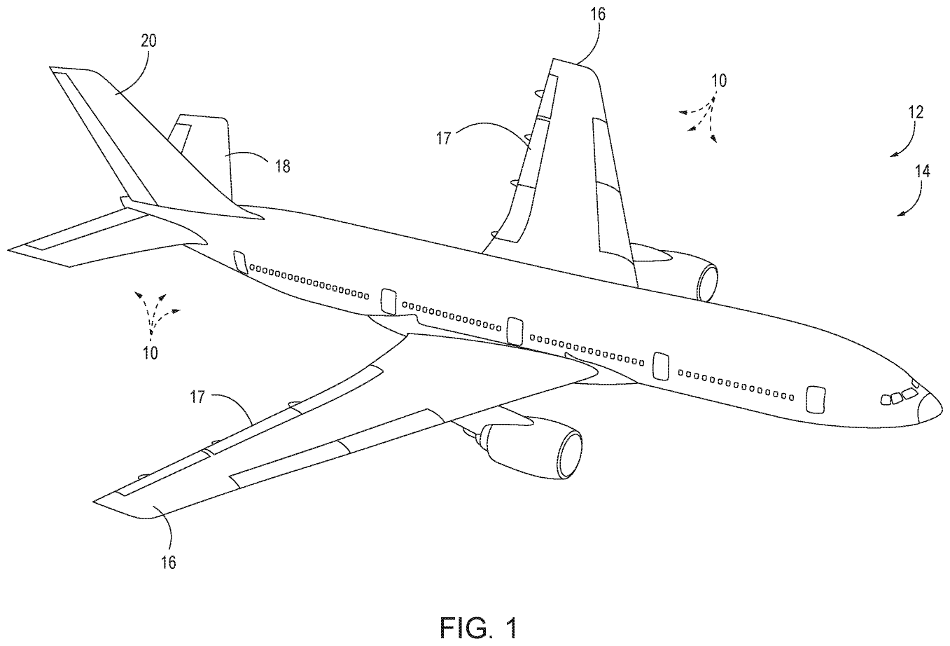

With reference to FIG. 1, one or more structural composite airfoils 10 may be included in an apparatus 12. Structural composite airfoils 10 may be utilized in many different industries and applications, such as the aerospace, automotive, military, architecture, wind power generation, remote control aircraft, marine, recreation, and/or motorsport industries. In FIG. 1, an example of apparatus 12 that may include one or more structural composite airfoils 10 generally is illustrated in the form of an aircraft 14. Aircraft 14 may take any suitable form, including commercial aircraft, military aircraft, or any other suitable aircraft. While FIG. 1 illustrates aircraft 14 in the form of a fixed wing aircraft, other types and configurations of aircraft are within the scope of aircraft 14 according to the present disclosure, including (but not limited to) rotorcraft and helicopters.

Apparatus 12 (e.g., aircraft 14) may include one or more structural composite airfoils 10. As illustrative, non-exclusive examples, structural composite airfoils 10 may be utilized in wings 16 (e.g., flaps 17, which may be inboard or outboard flaps), though other components of aircraft 14, such as horizontal stabilizers 18, vertical stabilizers 20, and others additionally or alternatively may include one or more structural composite airfoils 10. Other applications in aircraft 14 (or other apparatus 12) for structural composite airfoils 10 may include other wing control surfaces, ailerons, flaperons, air brakes, elevators, slats, spoilers, canards, rudders, and/or winglets. In other industries, examples of apparatus 12 (including one or more structural composite airfoils 10) may include or be a portion of space satellites, transit vehicles, shipping containers, rapid transit vehicles, automobile bodies, propeller blades, turbine blades, and/or marine vehicles, among others.

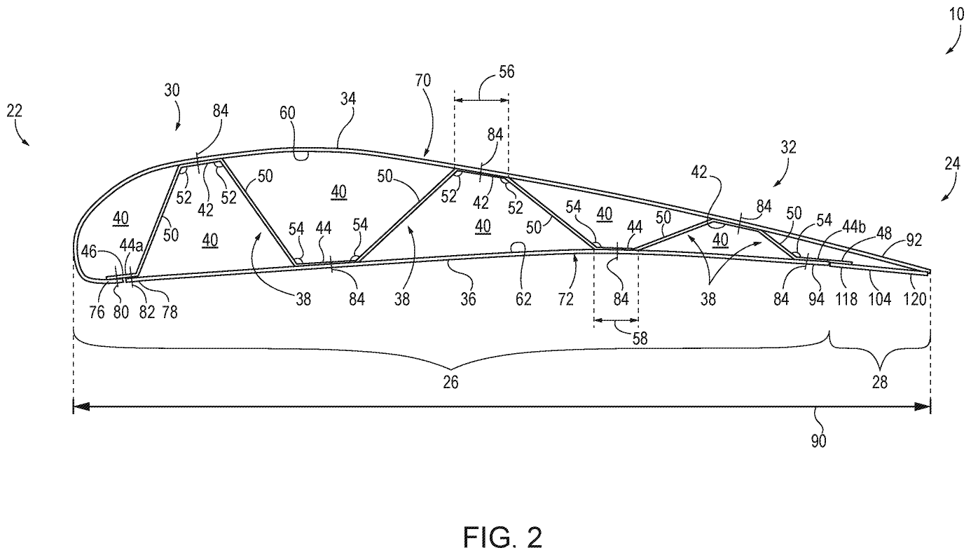

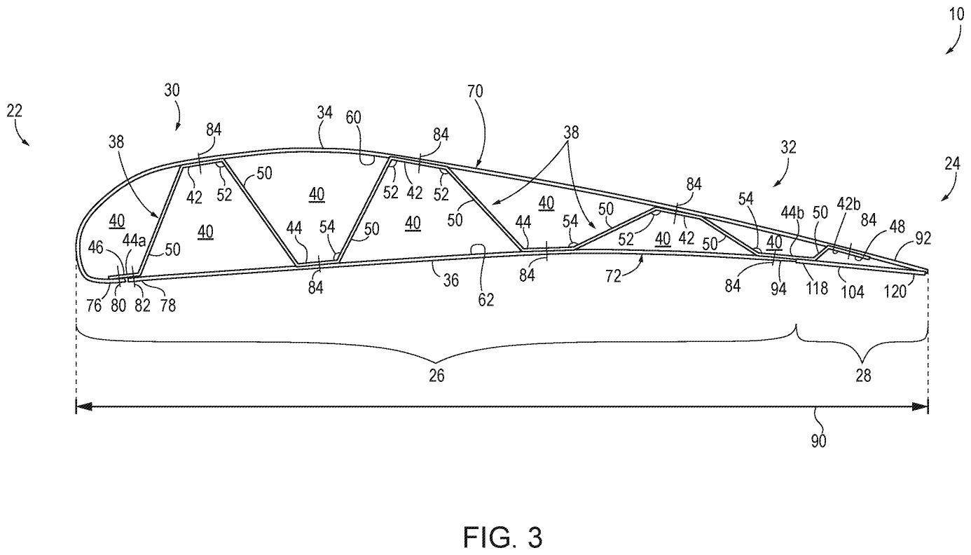

FIGS. 2-3 provide illustrative, non-exclusive examples of structural composite airfoils 10 according to the present disclosure. In general, elements that are shown in solid lines may not be essential to all examples, and an element shown in solid lines may be omitted from a particular example without departing from the scope of the present disclosure. Structural composite airfoil 10 has a leading edge 22 and a trailing edge 24, and generally includes a primary structural element 26 and a secondary structural element 28. As used herein, a “primary structural element” is an element or structure which carries flight, ground, or pressurization loads, and whose failure would reduce the structural integrity of the apparatus or assembly of which structural composite airfoil 10 is a part. As used herein, a “secondary structural element” is an element or structure whose failure does not affect the safety of the apparatus or assembly of which structural composite airfoil 10 is a part. Primary structural element 26 extends from a leading edge region 30 to a trailing edge region 32. As shown in FIGS. 2-3, leading edge region 30 may define, or form, leading edge 22 of structural composite airfoil 10 and generally has a bullnose shape defined by an upper skin panel 34. Currently disclosed structural composite airfoils 10, therefore, may provide an aerodynamic advantage in providing leading edge 22 without disruptions in the leading edge surface, and/or without discrete structures or components forming leading edge 22. Disclosed structural composite airfoils 10 may thus advantageously provide a smooth, uninterrupted surface an aerodynamically sensitive regions of the airfoil 10. Trailing edge region 32 may be said to be the region of primary structural element 26 that is closest to trailing edge 24, though trailing edge region 32 of primary structural element 26 does not define trailing edge 24 of structural composite airfoil 10 in the examples shown in FIGS. 2-3. As used herein, a first element or structure is said to be “aft” of another element or structure if the first element or structure is positioned closer to trailing edge 24 than is the other element or structure. Similarly, as used herein, a first element or structure is said to be “forward” of another element or structure if the first element or structure is positioned closer to leading edge 22 than is the other element or structure.

Primary structural element 26 includes at least upper skin panel 34, a lower skin panel 36, and a spar 38. An internal volume 40 is defined between upper skin panel 34 and lower skin panel 36. Spar 38 includes a plurality of upper flanges 42 coupled to upper skin panel 34, and a plurality of lower flanges 44 coupled to lower skin panel 36. Examples of presently disclosed structural composite airfoils 10 may advantageously provide for interfacing between components or elements without utilizing splice straps, and/or may allow for a part count reduction by reducing or eliminating the number of splice straps, nut plates, and/or other fasteners used in assembling structural composite airfoils 10.

Spar 38 extends spanwise across the width of structural composite airfoil 10 (into the page) and lengthwise along a chord length 90 of structural composite airfoil 10. Along chord length 90, spar 38 extends from a spar leading edge end 46 to a spar trailing edge end 48. Upper skin panel 34 extends from an upper leading edge end 76 to an upper trailing edge end 92. Upper leading edge end 76 corresponds to the end of upper skin panel 34 that is closest to leading edge 22 of structural composite airfoil 10, and upper trailing edge end 92 corresponds to the end of upper skin panel 34 that is closest to trailing edge 24 of structural composite airfoil 10. Upper skin panel 34 may be continuous from upper leading edge end 76 to upper trailing edge end 92, and thus may be continuous from trailing edge 24 all the way along an upper airfoil surface 70, and around the bullnose of leading edge 22 to a location where upper leading edge end 76 is coupled to spar 38, adjacent a lower leading edge end 78 of lower skin panel 36. Similarly, lower skin panel 36 generally extends from lower leading edge end 78 to a lower trailing edge end 94. Lower leading edge end 78 corresponds to the end of lower skin panel 36 that is closest to leading edge 22, and lower trailing edge end 94 corresponds to the end of lower skin panel 36 that is closest to trailing edge 24.

Spar 38 includes a respective elongated span 50 extending between each respective upper flange 42 and respective adjacent lower flange 44. In some examples, each respective elongated span 50 is non-parallel and non-perpendicular to upper skin panel 34. Similarly, each respective elongated span 50 is non-parallel and non-perpendicular to lower skin panel 36 in some examples. Because each upper flange 42 is coupled to upper skin panel 34 and each lower flange 44 is coupled to lower skin panel 36, each elongated span 50 effectively extends from upper skin panel 34 to lower skin panel 36. The respective lengths of elongated spans 50 vary within structural composite airfoil 10, based on the shape of the airfoil. For example, elongated spans 50 positioned within leading edge region 30 are generally longer than elongated spans 50 positioned within trailing edge region 32, though the angles of each elongated span 50 may be adjusted such that the respective lengths of elongated spans 50 are also adjusted, based on the spacing between a respective adjacent upper flange 42/lower flange 44 pair. Each respective upper flange 42 forms a respective angle 52 with one or more respective elongated spans 50, with each respective angle 52 being greater than 45 degrees, greater than 90 degrees, and/or greater than 135 degrees in some examples. Similarly, each respective lower flange 44 forms a respective angle 54 with one or more respective elongated spans 50, with each respective angle 54 being greater than 45 degrees, greater than 90 degrees, and/or greater than 135 degrees in some examples. The plurality of elongated spans 50 generally are configured to stabilize upper skin panel 34 and lower skin panel 36, and may replace or reduce the number of stringers in some examples of structural composite airfoil 10.

The number of upper flanges 42, lower flanges 44, and elongated spans 50 of spar 38 may vary depending on the airfoil shape and chord length 90 of structural composite airfoil 10. In the example of FIG. 2, structural composite airfoil 10 includes four lower flanges 44, three upper flanges 42, and six elongated spans 50. In the example of FIG. 3, structural composite airfoil 10 includes four lower flanges 44, four upper flanges 42, and seven elongated spans 50. Other examples of structural composite airfoil 10 may include more or fewer upper flanges 42, more or fewer lower flanges 44, and/or more or fewer elongated spans 50. For example, spar 38 may include one, two, three, four, five, six, seven, eight, nine, and/or ten or more upper flanges 42, and/or one, two, three, four, five, six, seven, eight, nine, and/or ten or more lower flanges 44. In some examples, upper flanges 42 and/or lower flanges 44 may be sized according to fastener diameter. For example, a width 56 of one or more upper flanges 42 may be minimized to still allow for fastener placement with sufficient edge margin and tool access. Additionally or alternatively, a width 58 of one or more lower flanges 44 may be minimized to still allow for fastener placement with sufficient edge margin and tool access.

Spar 38 is generally a monolithic body. In other words, the plurality of upper flanges 42, the plurality of lower flanges 44, and the plurality of elongated spans 50 are generally integrally formed together. For example, the entire spar 38 may be a single molded piece. In some examples, spar 38 may be formed of titanium (e.g., superplastically formed titanium), a thermoplastic material, a hydroformed metallic sheet metal, a die-pressed metallic sheet metal, a thermoset composite, and/or a thermoplastic composite, though may be formed of other polymers, metals, and/or composite materials in some examples. As illustrative examples, spar 38 may be formed via thermoplastic molding, hydropressing, and/or layup of prepreg fabric plies. Spar 38 generally is sized with respect to structural composite airfoil 10 to extend along a majority of a chord length 90 of structural composite airfoil 10. In some examples, spar 38 is sized with respect to structural composite airfoil 10 such that it extends from leading edge region 30 of primary structural element 26 to trailing edge region 32 of primary structural element 26. For example, spar leading edge end 46 may be positioned within leading edge region 30 of primary structural element 26, and/or adjacent leading edge 22 of structural composite airfoil 10. Spar trailing edge end 48 may be positioned within trailing edge region 32 of primary structural element. In some examples, spar trailing edge end 48 may be positioned aft of trailing edge region 32 of primary structural element 26. For example, spar trailing edge end 48 may be positioned adjacent trailing edge 24, and/or may be coupled to secondary structural element 28.

In some examples, each respective upper flange 42 is substantially parallel to upper skin panel 34 at a respective location wherein the respective upper flange 42 is coupled to upper skin panel 34. Additionally or alternatively, each respective upper flange 42 may be complementary to upper skin panel 34 at a respective location of upper skin panel 34 where the respective upper flange 42 is coupled to upper skin panel 34. Similarly, each lower flange 44 may be substantially parallel to lower skin panel 36 at a respective location where the respective lower flange 44 is coupled to lower skin panel 36. Additionally or alternatively, each respective lower flange 44 may be complementary to lower skin panel 36 at a respective location of lower skin panel 36 where the respective lower flange 44 is coupled to lower skin panel 36. The sizes and/or positions of upper flanges 42 and lower flanges 44 may be configured to prevent or reduce skin buckling of upper skin panel 34 and/or lower skin panel 36. For example, upper flanges 42 and lower flanges 44 may be sized and spaced apart from one another based on skin loads of upper skin panel 34 and lower skin panel 36, such that upper flanges 42 and lower flanges 44 are configured to transfer loads between upper skin panel 34 and lower skin panel 36. Additionally or alternatively, upper flanges 42 and/or lower flanges 44 may be positioned to coincide with external support fitting attachments. For example, in instances where structural composite airfoil 10 is a flap for an aircraft wing, such external support fitting attachments may include carrier beams or hinge fittings that physically connect the flap to the aircraft wing. Additionally or alternatively, spar 38 may be formed and arranged to be continuously and regularly spaced with respect to upper skin panel 34 and lower skin panel 36 to increase and/or optimize structural efficiency.

Upper leading edge end 76 and lower leading edge end 78 each may be coupled to spar 38 within leading edge region 30, as shown in FIGS. 2-3. In this manner, a forward-most lower flange 44 (indicated at 44a) is coupled to upper skin panel 34 and lower skin panel 36. For example, upper leading edge end 76 and lower leading edge end 78 each is coupled to forward-most lower flange 44a, with said forward-most lower flange 44a generally corresponding to spar leading edge end 46. In other words, forward-most lower flange 44a is adjacent, and/or forms, spar leading edge end 46. Upper leading edge end 76 and lower leading edge end 78 may be said to be indirectly coupled to each other by virtue of each being coupled to forward-most lower flange 44a, though in some examples upper leading edge end 76 and lower leading edge end 78 may additionally or alternatively be directly coupled to each other.

The aft-most lower flange 44 (indicated at 44b) also may be coupled to lower skin panel 36, as shown in FIGS. 2-3. For example, aft-most lower flange 44b may be coupled to lower skin panel 36 adjacent lower trailing edge end 94. Aft-most lower flange 44b may be adjacent spar trailing edge end 48 and/or define spar trailing edge end 48. For example, aft-most lower flange 44b defines spar trailing edge end 48 in the example shown in FIG. 2, though aft-most lower flange 44b does not define spar trailing edge end 48 in the example shown in FIG. 3 (though it is positioned adjacent to spar trailing edge end 48 in FIG. 3). In the example of FIG. 3, spar trailing edge end 48 is defined by the aft-most upper flange 42 (indicated at 42b), which is aft of aft-most lower flange 44b. In FIG. 3, aft-most upper flange 42b is coupled to upper skin panel 34 adjacent upper trailing edge end 92. In some examples, aft-most lower flange 44b is coupled to secondary structural element 28, in addition to lower skin panel 36. For example, aft-most lower flange 44b may be secured to lower skin panel 36 such that aft-most lower flange 44b overlaps lower trailing edge end 94 and secondary structural element 28, thereby splicing the two together. In these examples, aft-most lower flange 44b may be coupled to secondary structural element 28 via a fastener, and/or by being bonded to secondary structural element 28.

Structural composite airfoil 10 has upper airfoil surface 70 and a lower airfoil surface 72. Upper airfoil surface 70 is defined by upper skin panel 34, and extends from a midpoint of the bullnose shape of leading edge 22 to trailing edge 24, along the upper side of structural composite airfoil 10. Lower airfoil surface 72 may be defined by both upper skin panel 34 and lower skin panel 36. For example, within leading edge region 30 of primary structural element 26, upper leading edge end 76 of upper skin panel 34 forms part of lower airfoil surface 72. Additionally or alternatively, lower airfoil surface 72 may be partially defined by secondary structural element 28.

Structural composite airfoil 10 may include one or more fasteners securing various components to each other, as will be appreciated by those of ordinary skill in the art. In the examples shown in FIGS. 2-3, a first fastener 80 couples upper leading edge end 76 of upper skin panel 34 to one of lower flanges 44 of spar 38 (e.g., forward-most lower flange 44a), and a second fastener 82 couples lower leading edge end 78 of lower skin panel 36 to the same lower flange 44. In some examples, first fastener 80 is a plurality of first fasteners 80 securing upper skin panel 34 to forward-most lower flange 44a, spaced apart along the width of structural composite airfoil 10 (the width of the airfoil extending into/out of the page). Similar to first fastener 80, in some examples, second fastener 82 is a plurality of second fasteners 82 securing lower skin panel 36 to forward-most lower flange 44a, spaced apart along the width of structural composite airfoil 10 (the width of the airfoil extending into/out of the page).

Generally, at least one fastener 84 couples each respective upper flange 42 to upper skin panel 34, such that each upper flange 42 is coupled to upper skin panel 34 adjacent an upper inner surface 60 of upper skin panel 34. Similarly, at least one fastener 84 generally couples each respective lower flange 44 to lower skin panel 36, such that each lower flange 44 is coupled to lower skin panel 36 adjacent a lower inner surface 62 of lower skin panel 36. First fastener 80 and second fastener 82 are examples of fastener 84. In some examples, upper skin panel 34 may be directly coupled to the plurality of upper flanges 42 without using splice straps. Additionally or alternatively, lower skin panel 36 may be directly coupled to the plurality of lower flanges 44 without using splice straps. Additionally or alternatively, one or more fasteners 84 may be used to couple upper trailing edge end 92 to lower trailing edge end 94.

Each of upper skin panel 34 and lower skin panel 36 may be a composite panel formed of a plurality of layers (plies) of a fiber-reinforced polymer laminated together. For example, upper skin panel 34 and lower skin panel 36 may be formed of carbon fiber reinforced polymer material or fiberglass reinforced polymer material. In other examples, upper skin panel 34 and/or lower skin panel 36 may be a metallic, polymer, or other suitable material. In some examples, upper skin panel 34 is not core stiffened. As used herein, “core stiffened” refers to skin panels having at least a first skin and a low density core material coupled to the skin. Core stiffened materials generally further include a second skin, with the core material sandwiched between the first and second skins to form a sandwich panel. Suitable materials for forming core stiffened portions are well known in the art, and include honeycomb core materials and metallic core materials, among others. While conventional structural airfoils often include at least a portion of its panels being core-stiffened, presently disclosed structural composite airfoils 10 may be configured such that spar 38 provides sufficient strengthening and reinforcement that upper skin panel 34 may not be core stiffened, or may be core stiffened to a lesser extent than in conventional airfoils. Additionally or alternatively, lower skin panel 36 is not core stiffened in some examples or may be core stiffened to a lesser extent than in conventional airfoils. In other words, upper skin panel 34 and/or lower skin panel 36 may be a simple solid laminate skin in presently disclosed structural composite airfoils 10, which may significantly lower manufacturing costs in some examples.

Structural composite airfoil 10 has chord length 90, and a position along chord length 90 may be defined in terms of a percentage of a distance along chord length 90 from leading edge 22. In these terms, lower trailing edge end 94 may be positioned between 80%-95% of chord length 90 away from leading edge 22. Upper leading edge end 76 and lower leading edge end 78 each may be coupled to forward-most lower flange 44a within 0-20% of chord length 90 away from leading edge 22. In a specific example, upper leading edge end 76 and lower leading edge end 78 each may be coupled to forward-most lower flange 44a within 5-10% of chord length 90 away from leading edge 22. Additionally or alternatively, spar 38 may extend along at least 50% of chord length 90, at least 60% of chord length 90, at least 70% of chord length 90, at least 80% of chord length 90, and/or at least 90% of chord length 90.

Trailing edge 24 of structural composite airfoil 10 may be defined by secondary structural element 28. In various examples of structural composite airfoil 10, secondary structural element 28 may include a wedge closeout, a duckbill closeout, a bonded closeout, and/or a riveted closeout. Examples of suitable trailing edge closeouts are also disclosed in U.S. Pat. No. 10,532,804, issued on Jan. 14, 2020, and titled AERODYNAMIC CONTROL SURFACE AND ASSOCIATED TRAILING EDGE CLOSE-OUT METHOD, the entire disclosure of which is hereby incorporated by reference herein in its entirety, for all purposes. Upper trailing edge end 92 of upper skin panel 34 may be coupled to secondary structural element 28, and/or may be coupled to lower skin panel 36 (e.g., lower trailing edge end 94). In the example shown in FIGS. 2-3, upper trailing edge end 92 extends to trailing edge 24 of structural composite airfoil 10, and secondary structural element 28 is coupled to both upper skin panel 34 and to aft-most lower flange 44b. Additionally or alternatively, lower trailing edge end 94 may be coupled to secondary structural element 28.

A trailing edge closeout cover 104 may at least partially define secondary structural element 28 and/or trailing edge 24 of structural composite airfoil 10. A first cover end region 118 of trailing edge closeout cover 104 may be bonded to aft-most lower flange 44b, as shown in FIGS. 2-3. Additionally or alternatively, first cover end region 118 may be riveted or otherwise fastened or coupled to aft-most lower flange 44b. In some examples, aft-most lower flange 44b may effectively serve to splice together first cover end region 118 and lower trailing edge end 94 of lower skin panel 36. Any gaps remaining at the interface of lower trailing edge end 94, aft-most lower flange 44b, and/or first cover end region 118 (or elsewhere on structural composite airfoil 10) may be filled with a sealant, a filler material, and/or a resin, and then smoothed.

A second cover end region 120 of trailing edge closeout cover 104 may include an integral wedge that may be coupled (e.g., bonded and/or coupled via one or more fasteners) to upper skin panel 34. Alternatively, an integral wedge may be integrally formed with upper skin panel 34 (e.g., within upper trailing edge end 92). In still other examples, structural composite airfoil 10 may include an integral wedge that is a discrete component separate from trailing edge closeout cover 104 and separate from upper skin panel 34, and which may be bonded or otherwise coupled to upper skin panel 34 and/or trailing edge closeout cover 104. Such integral wedges may be formed, for example, by building up plies of material, molding, and/or by machining a mating face profile to mate with upper skin panel 34.

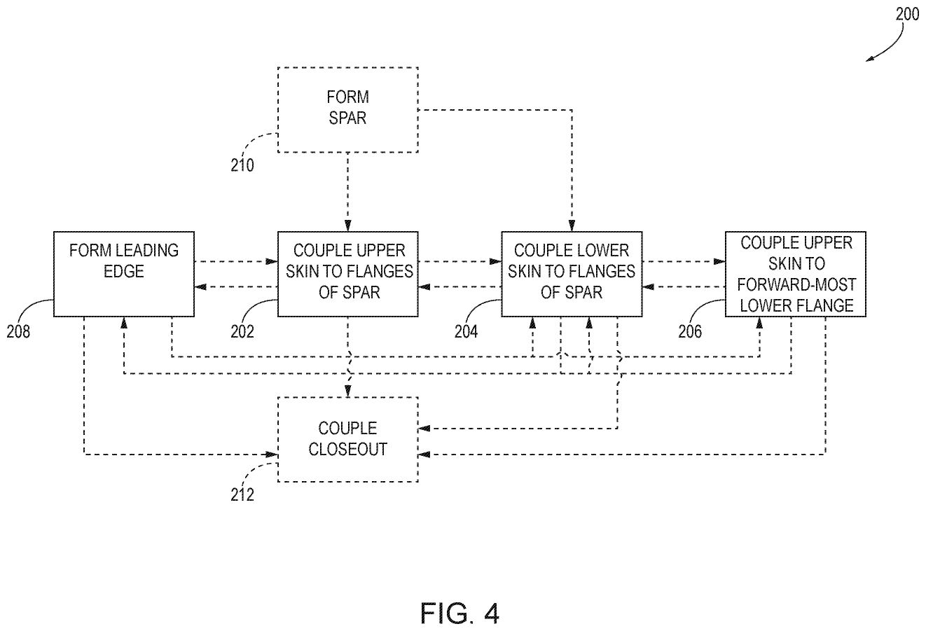

FIG. 4 schematically provides a flowchart that represents illustrative, non-exclusive examples of methods 200 according to the present disclosure. In FIG. 4, some steps are illustrated in dashed boxes indicating that such steps may be optional or may correspond to an optional version of a method according to the present disclosure. That said, not all methods 200 according to the present disclosure are required to include the steps illustrated in solid boxes. The methods 200 and steps illustrated in FIG. 4 are not limiting and other methods and steps are within the scope of the present disclosure, including methods having greater than or fewer than the number of steps illustrated, as understood from the discussions herein.

Methods 200 generally include coupling an upper skin panel (e.g., upper skin panel 34) to a plurality of upper flanges of a spar (e.g., upper flanges 42 of spar 38), at 202, and coupling a lower skin panel (e.g., lower skin panel 36) to a plurality of lower flanges of the spar (e.g., lower flanges 44), at 204. Methods 200 also include forming a leading edge of the structural composite airfoil (e.g., leading edge 22) with the upper skin panel at 208, and coupling an upper leading edge end of the upper skin panel (e.g., upper leading edge end 76) to a forward-most lower flange of the spar (e.g., forward-most lower flange 44a), at 206. The coupling the lower skin panel to the plurality of lower flanges at 204 generally includes coupling a lower leading edge end of the lower skin panel (e.g., lower leading edge end 78) to the forward-most lower flange of the spar. The coupling the upper skin panel to the upper flanges at 202 and/or coupling the lower skin panel to the lower flanges at 204 may be performed without using splice straps, in some methods 200. Methods 200 also may include coupling a closeout (e.g., trailing edge closeout cover 104) and/or a different secondary structural element 28 to the upper skin panel and/or the lower skin panel, at 212. Additionally or alternatively, methods 200 may include forming the spar at 210, such as via thermoplastic molding, hydropressing, and/or layup of prepreg fabric plies.

Illustrative, non-exclusive examples of inventive subject matter according to the present disclosure are described in the following enumerated paragraphs:

A1. A structural composite airfoil (10) having a leading edge (22) and a trailing edge (24), the structural composite airfoil (10) comprising:

a primary structural element (26) extending from a leading edge region (30) to a trailing edge region (32), wherein the leading edge region (30) of the primary structural element (26) forms the leading edge (22) of the structural composite airfoil (10), wherein the primary structural element (26) comprises:
an upper skin panel (34) extending from an upper leading edge end (76) to an upper trailing edge end (92), wherein the leading edge region (30) of the primary structural element (26) has a bullnose shape defined by the upper skin panel (34);
a lower skin panel (36) extending from a lower leading edge end (78) to a lower trailing edge end (94);
an internal volume (40) defined between the upper skin panel (34) and the lower skin panel (36); and
a spar (38) comprising a plurality of upper flanges (42) coupled to the upper skin panel (34), wherein the spar (38) further comprises a plurality of lower flanges (44) coupled to the lower skin panel (36), wherein the spar (38) extends spanwise across the structural composite airfoil (10), and wherein the spar (38) extends along a chord length (90) of the structural composite airfoil (10) from a spar leading edge end (46) to a spar trailing edge end (48); and

a secondary structural element (28) defining the trailing edge (24) of the structural composite airfoil (10).

A2. The structural composite airfoil (10) of paragraph A1, wherein the upper skin panel (34) is continuous from the upper leading edge end (76) to the upper trailing edge end (92).

A3. The structural composite airfoil (10) of any of paragraphs A1-A2, wherein the spar (38) comprises a respective elongated span (50) extending between each respective upper flange (42) and respective adjacent lower flange (44).

A4. The structural composite airfoil (10) of paragraph A3, wherein each respective elongated span (50) is non-parallel and non-perpendicular to the upper skin panel (34).

A5. The structural composite airfoil (10) of paragraph A3 or A4, wherein each respective elongated span (50) is non-parallel and non-perpendicular to the lower skin panel (36).

A6. The structural composite airfoil (10) of any of paragraphs A1-A5, wherein each upper flange (42) of the plurality of upper flanges (42) is substantially parallel to the upper skin panel (34) at a respective location where the respective upper flange (42) is coupled to the upper skin panel (34).

A7. The structural composite airfoil (10) of any of paragraphs A1-A6, wherein each respective upper flange (42) of the plurality of upper flanges (42) is complementary to the upper skin panel (34) at a respective location of the upper skin panel (34) where the respective upper flange (42) is coupled to the upper skin panel (34).

A8. The structural composite airfoil (10) of any of paragraphs A1-A7, wherein each lower flange (44) of the plurality of lower flanges (44) is substantially parallel to the lower skin panel (36) at a respective location where the respective lower flange (44) is coupled to the lower skin panel (36).

A9. The structural composite airfoil (10) of any of paragraphs A1-A6, wherein each respective lower flange (44) of the plurality of lower flanges (44) is complementary to the lower skin panel (36) at a respective location of the lower skin panel (36) where the respective lower flange (44) is coupled to the lower skin panel (36).

A10. The structural composite airfoil (10) of any of paragraphs A1-A9, wherein the spar (38) is a monolithic body.

A11. The structural composite airfoil (10) of any of paragraphs A1-A10, wherein the spar (38) comprises titanium.

A12. The structural composite airfoil (10) of any of paragraphs A1-A11, wherein the spar (38) comprises a thermoplastic material.

A13. The structural composite airfoil (10) of any of paragraphs A1-A12, wherein the spar (38) is a single molded piece.

A14. The structural composite airfoil (10) of any of paragraphs A1-A13, wherein the spar (38) extends from the leading edge region (30) of the primary structural element (26) to the trailing edge region (32) of the primary structural element (26).

A15. The structural composite airfoil (10) of any of paragraphs A1-A14, wherein a forward-most lower flange (44a) of the plurality of lower flanges (44) is coupled to the lower skin panel (36) and the upper skin panel (34).

A16. The structural composite airfoil (10) of paragraph A15, wherein the forward-most lower flange (44a) is adjacent the spar leading edge end (46).

A17. The structural composite airfoil (10) of any of paragraphs A1-A16, wherein a/the forward-most lower flange (44a) of the plurality of lower flanges (44) is coupled to the upper leading edge end (76) of the upper skin panel (34) and the lower leading edge end (78) of the lower skin panel (36).

A18. The structural composite airfoil (10) of any of paragraphs A1-A17, wherein an aft-most lower flange (44b) of the plurality of lower flanges (44) is coupled to the lower skin panel (36) adjacent the lower trailing edge end (94).

A19. The structural composite airfoil (10) of any of paragraphs A1-A18, wherein an/the aft-most lower flange (44b) of the plurality of lower flanges (44) is adjacent and/or defines the spar trailing edge end (48).

A20. The structural composite airfoil (10) of any of paragraphs A1-A19, wherein an/the aft-most lower flange (44b) of the plurality of lower flanges (44) is coupled to the secondary structural element (28).

A21. The structural composite airfoil (10) of any of paragraphs A1-A20, wherein an/the aft-most lower flange (44b) of the plurality of lower flanges (44) overlaps the lower trailing edge end (94) of the lower skin panel (36) and the secondary structural element (28).

A22. The structural composite airfoil (10) of any of paragraphs A1-A21, wherein an aft-most upper flange (42b) of the plurality of upper flanges (42) is adjacent and/or defines the spar trailing edge end (48).

A23. The structural composite airfoil (10) of any of paragraphs A1-A22, wherein an/the aft-most upper flange (42b) of the plurality of upper flanges (42) is coupled to the secondary structural element (28).

A24. The structural composite airfoil (10) of any of paragraphs A1-A23, wherein the structural composite airfoil (10) comprises a respective fastener (84) coupling each respective upper flange (42) of the plurality of upper flanges (42) to the upper skin panel (34).

A25. The structural composite airfoil (10) of any of paragraphs A1-A24, wherein the structural composite airfoil (10) comprises a respective fastener (84) coupling each respective lower flange (44) of the plurality of lower flanges (44) to the lower skin panel (36).

A26. The structural composite airfoil (10) of any of paragraphs A1-A25, wherein an/the forward-most lower flange (44a) of the plurality of lower flanges (44) is coupled to the upper skin panel (34) via a first fastener (80), and wherein the forward-most lower flange (44a) of the plurality of lower flanges (44) is coupled to the lower skin panel (36) via a second fastener (82).

A27. The structural composite airfoil (10) of any of paragraphs A1-A26, wherein a position along the chord length (90) of the structural composite airfoil (10) may be defined by a percentage of a distance along the chord length (90) from the leading edge (22).

A28. The structural composite airfoil (10) of paragraph A27, wherein the lower trailing edge end (94) is positioned between 80%-95% of the chord length (90) away from the leading edge (22).

A29. The structural composite airfoil (10) of paragraph A27 or A28, wherein the spar (38) extends along at least 50% of the chord length (90), at least 60% of the chord length (90), at least 70% of the chord length (90), at least 80% of the chord length (90), and/or at least 90% of the chord length (90).

A30. The structural composite airfoil (10) of any of paragraphs A1-A29, wherein the upper skin panel (34) is coupled to the plurality of upper flanges (42) without a splice strap.

A31. The structural composite airfoil (10) of any of paragraphs A1-A30, wherein the lower skin panel (36) is coupled to the plurality of lower flanges (44) without a/the splice strap.

A32. The structural composite airfoil (10) of any of paragraphs A1-A31, wherein the upper skin panel (34) is not core stiffened.

A33. The structural composite airfoil (10) of any of paragraphs A1-A32, wherein the lower skin panel (36) is not core stiffened.

A34. The structural composite airfoil (10) of any of paragraphs A1-A33, wherein the upper skin panel (34) comprises fiberglass or carbon fiber.

A35. The structural composite airfoil (10) of any of paragraphs A1-A34, wherein the lower skin panel (36) comprises fiberglass or carbon fiber.

A36. The structural composite airfoil (10) of any of paragraphs A1-A35, wherein the spar (38) comprises a plurality of an/the elongated spans (50) that are configured to stabilize the upper skin panel (34) and the lower skin panel (36).

A37. The structural composite airfoil (10) of any of paragraphs A1-A36, wherein sizes and/or positions of the plurality of upper flanges (42) and the sizes and/or positions of the plurality of lower flanges (44) are configured to prevent or reduce skin buckling of the upper skin panel (34) and/or the lower skin panel (36).

A38. The structural composite airfoil (10) of any of paragraphs A1-A37, wherein the spar (38) is formed via thermoplastic molding, hydropressing, and/or layup of prepreg fabric plies.

A39. The structural composite airfoil (10) of any of paragraphs A1-A38, wherein each upper flange (42) of the plurality of upper flanges (42) forms a respective angle (52) with one or more adjacent elongated spans (50) of the spar (38), and wherein the respective angle (52) is greater than 45 degrees.

A40. The structural composite airfoil (10) of any of paragraphs A1-A39, wherein each lower flange (44) of the plurality of lower flanges (44) forms a respective angle (54) with one or more adjacent elongated spans (50) of the spar (38), and wherein the respective angle (54) is greater than 45 degrees.

A41. The structural composite airfoil (10) of any of paragraphs A1-A40, wherein the structural composite airfoil (10) is a trailing edge flap (17), an aileron, a flaperon, an air brake, an elevator, a slat, a spoiler, a canard, a rudder, and/or a winglet.

A42. The structural composite airfoil (10) of any of paragraphs A1-A41, wherein the secondary structural element (28) comprises a wedge closeout.

A43. The structural composite airfoil (10) of any of paragraphs A1-A42, wherein the secondary structural element (28) comprises a duckbill closeout.

A44. The structural composite airfoil (10) of any of paragraphs A1-A43, wherein the secondary structural element (28) comprises a bonded closeout.

A45. The structural composite airfoil (10) of any of paragraphs A1-A44, wherein the secondary structural element (28) comprises a riveted closeout.

A46. The structural composite airfoil (10) of any of paragraphs A1-A45, wherein the lower trailing edge end (94) of the lower skin panel (36) end is coupled to the secondary structural element (28).

A47. The structural composite airfoil (10) of any of paragraphs A1-A46, wherein the upper trailing edge end (92) of the upper skin panel (34) is coupled to the secondary structural element (28).

A48. The structural composite airfoil (10) of any of paragraphs A1-A47, wherein the structural composite airfoil (10) comprises an upper airfoil surface (70) and a lower airfoil surface (72).

A49. The structural composite airfoil (10) of paragraph A48, wherein the upper airfoil surface (70) is defined by the upper skin panel (34).

A50. The structural composite airfoil (10) of paragraph A48 or A49, wherein the lower airfoil surface (72) is defined by the upper skin panel (34) and the lower skin panel (36).

A51. The structural composite airfoil (10) of any of paragraphs A46-A48, wherein the upper leading edge end (76) of the upper skin panel (34) forms part of the lower airfoil surface (72) of the structural composite airfoil (10).

B1. An aircraft (14) comprising the structural composite airfoil (10) of any of paragraphs A1-A51.

B2. A trailing edge flap (17) for an aircraft (14) comprising the structural composite airfoil (10) of any of paragraphs A1-A51.

C1. A method (200) of assembling a structural composite airfoil (10), the method (200) comprising:

coupling (202) an upper skin panel (34) to a plurality of upper flanges (42) of a spar (38), wherein the structural composite airfoil (10) extends from a leading edge (22) to a trailing edge (24), wherein the spar (38) further comprises a plurality of lower flanges (44), and an elongated span (50) extending between each adjacent upper flange (42) and lower flange (44), and wherein the upper skin panel (34) extends from an upper leading edge end (76) to an upper trailing edge end (92);

coupling (204) a lower skin panel (36) to the plurality of lower flanges (44) of the spar (38) such that an internal volume (40) is defined between the upper skin panel (34) and the lower skin panel (36), wherein the upper skin panel (34), the lower skin panel (36), and the spar (38) together form at least a portion of a primary structural element (26) of the structural composite airfoil (10), and wherein the lower skin panel (36) extends from a lower leading edge end (78) to a lower trailing edge end (94);

forming (208) the leading edge (22) of the structural composite airfoil (10) with the upper skin panel (34), wherein the leading edge (22) has a bullnose shape; and

coupling (206) the upper leading edge end (76) of the upper skin panel (34) to a forward-most lower flange (44a) of the plurality of lower flanges (44).

C2. The method (200) of paragraph C1, wherein the coupling (204) the lower skin panel (36) to the plurality of lower flanges (44) comprises coupling the lower leading edge end (78) of the lower skin panel (36) to the forward-most lower flange (44a).

C3. The method (200) of any of paragraphs C1-C2, wherein the structural composite airfoil (10) is the structural composite airfoil (10) of any of paragraphs A1-A51.

C4. The method (200) of any of paragraphs C1-C3, wherein the coupling (202) the upper skin panel (34) is performed without using a/the splice strap.

C5. The method (200) of any of paragraphs C1-C4, wherein the coupling (204) the lower skin panel (36) is performed without using a/the splice strap.

C6. The method (200) of any of paragraphs C1-05, further comprising coupling (212) a/the closeout to the upper skin panel (34) and/or the lower skin panel (36), wherein the closeout defines the trailing edge (24) of the structural composite airfoil (10).

C7. The method (200) of any of paragraphs C1-C6, further comprising forming (210) the spar (38) via thermoplastic molding, hydropressing, and/or layup of prepreg fabric plies.

D1. The use of the structural composite airfoil (10) of any of paragraphs A1-A51 as an inboard flap (17) for an aircraft (14).

D2. The use of the structural composite airfoil (10) of any of paragraphs A1-A51 as an outboard flap (17) for an aircraft (14).

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, or A, B, and C together, and optionally any of the above in combination with at least one other entity.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

1. A structural composite airfoil having a leading edge and a trailing edge, the structural composite airfoil comprising:
a primary structural element extending from a leading edge region to a trailing edge region, wherein the leading edge region of the primary structural element forms the leading edge of the structural composite airfoil, wherein the primary structural element comprises:
an upper skin panel extending from an upper leading edge end to an upper trailing edge end, wherein the leading edge region of the primary structural element has a bullnose shape defined by the upper skin panel;
a lower skin panel extending from a lower leading edge end to a lower trailing edge end;
an internal volume defined between the upper skin panel and the lower skin panel; and
a spar comprising a plurality of upper flanges coupled to the upper skin panel, wherein the spar further comprises a plurality of lower flanges coupled to the lower skin panel, wherein the spar extends spanwise across the structural composite airfoil, and wherein the spar extends along a chord length of the structural composite airfoil from a spar leading edge end to a spar trailing edge end; and
a secondary structural element defining the trailing edge of the structural composite airfoil.

2. The structural composite airfoil according to claim 1, wherein the spar comprises a respective elongated span extending between each respective upper flange and respective adjacent lower flange.

3. The structural composite airfoil according to claim 2, wherein each respective elongated span is non-parallel and non-perpendicular to the upper skin panel.

4. The structural composite airfoil according to claim 3, wherein each respective elongated span is non-parallel and non-perpendicular to the lower skin panel.

5. The structural composite airfoil according to claim 1, wherein each upper flange of the plurality of upper flanges is substantially parallel to the upper skin panel at a respective location where a respective upper flange is coupled to the upper skin panel.

6. The structural composite airfoil according to claim 1, wherein each lower flange of the plurality of lower flanges is substantially parallel to the lower skin panel at a respective location where a respective lower flange is coupled to the lower skin panel.

7. The structural composite airfoil according to claim 1, wherein the spar comprises a thermoplastic material.

8. The structural composite airfoil according to claim 1, wherein the spar is a monolithic body.

9. The structural composite airfoil according to claim 1, wherein a forward-most lower flange of the plurality of lower flanges is coupled to the lower skin panel and the upper skin panel, and wherein the forward-most lower flange is adjacent the spar leading edge end.

10. The structural composite airfoil according to claim 1, wherein an aft-most lower flange of the plurality of lower flanges defines the spar trailing edge end, and wherein the aft-most lower flange of the plurality of lower flanges is coupled to the secondary structural element.

11. The structural composite airfoil according to claim 1, wherein an aft-most upper flange of the plurality of upper flanges defines the spar trailing edge end, and wherein the aft-most upper flange is coupled to the secondary structural element.

12. The structural composite airfoil according to claim 1, wherein the structural composite airfoil comprises a respective first fastener coupling each respective upper flange of the plurality of upper flanges to the upper skin panel, and wherein the structural composite airfoil comprises a respective second fastener coupling each respective lower flange of the plurality of lower flanges to the lower skin panel.

13. The structural composite airfoil according to claim 1, wherein a position along the chord length of the structural composite airfoil may be defined by a percentage of a distance along the chord length from the leading edge, and wherein the lower trailing edge end is positioned between 80%-95% of the chord length away from the leading edge.

14. The structural composite airfoil according to claim 1, wherein the spar extends along at least 80% of the chord length.

15. The structural composite airfoil according to claim 1, wherein the upper skin panel is not core stiffened, wherein the lower skin panel is not core stiffened, wherein the upper skin panel comprises a fiber-reinforced polymer, and wherein the lower skin panel comprises the fiber-reinforced polymer.

16. The structural composite airfoil according to claim 1, wherein each upper flange of the plurality of upper flanges forms a respective angle with one or more adjacent elongated spans of the spar, and wherein the respective angle is greater than 90 degrees, and further wherein each lower flange of the plurality of lower flanges forms a respective angle with one or more adjacent elongated span s of the spar that is greater than 90 degrees.

17. The structural composite airfoil according to claim 1, wherein the structural composite airfoil is a trailing edge flap, an aileron, a flaperon, an air brake, an elevator, a slat, a spoiler, a canard, a rudder, and/or a winglet.

18. The structural composite airfoil according to claim 1, wherein the structural composite airfoil comprises an upper airfoil surface and a lower airfoil surface, wherein the upper airfoil surface is defined by the upper skin panel, and wherein the lower airfoil surface is defined by the upper skin panel and the lower skin panel.

19. A method of assembling a structural composite airfoil, the method comprising:
coupling an upper skin panel to a plurality of upper flanges of a spar, wherein the structural composite airfoil extends from a leading edge to a trailing edge, wherein the spar further comprises a plurality of lower flanges, and an elongated span extending between each adjacent upper flange and lower flange, and wherein the upper skin panel extends from an upper leading edge end to an upper trailing edge end;
coupling a lower skin panel to the plurality of lower flanges of the spar such that an internal volume is defined between the upper skin panel and the lower skin panel, wherein the upper skin panel, the lower skin panel, and the spar together form at least a portion of a primary structural element of the structural composite airfoil, and wherein the lower skin panel extends from a lower leading edge end to a lower trailing edge end;
forming the leading edge of the structural composite airfoil with the upper skin panel, wherein the leading edge has a bullnose shape; and
coupling the upper leading edge end of the upper skin panel to a forward-most lower flange of the plurality of lower flanges.

20. The method according to claim 19, wherein the coupling the lower skin panel to the plurality of lower flanges comprises coupling the lower leading edge end of the lower skin panel to the forward-most lower flange.
